(19) United States
(12) Patent Application Publication
(10) Pub. No.: US 2025/0334403 A1
(43) Pub. Date: Oct. 30, 2025

(54) Altitude Determination With Relative Pressure Change

(71) Applicant: NextNav, LLC, Santa Clara, CA (US)

(72) Inventors: Michael DORMODY, San Jose, CA (US); Badrinath NAGARAJAN, Cupertino, CA (US); Deepak JOSEPH, Oakton, VA (US); Arun RAGHUPATHY, Ramagondanahalli (IN); Robert ROVETTA, Cupertino, CA (US); Frank YENSHAW, San Mateo, CA (US)

(73) Assignee: NextNav, LLC, Santa Clara, CA (US)

(21) Appl. No.: 19/179,734

(22) Filed: Apr. 15, 2025

Related U.S. Application Data
(60) Provisional application No. 63/638,057, filed on Apr. 24, 2024.

(51) Int. Cl. G01C 5/06; G06F 16/29

(52) U.S. Cl. CPC G01C 5/06; G06F 16/29

(57) ABSTRACT

A pressure change is detected based on pressure measurement data from a barometric pressure sensor of a computing device. A 2D location of the computing device is determined. An altitude change of the computing device is determined using the pressure change. A cumulative altitude offset value is determined by adding the altitude change to a previous cumulative altitude offset value. A terrain-based altitude of the computing device is determined based on the 2D location and terrain data from a geodatabase. An altitude of the computing device is determined based on the terrain-based altitude and the cumulative altitude offset value.

### RELATED APPLICATIONS

This application claims priority to U.S. Provisional Patent Application No. 63/638,057, filed Apr. 24, 2024, all of which is incorporated herein by reference in its entirety.

### BACKGROUND

Determining a sufficiently precise 3D location of a computing device (e.g., typically a mobile device, such as a smartphone or other computing device that is carried and operated by a user) in an environment can be quite challenging, especially when the computing device is located in an urban environment or is located within a building or a moving vehicle. Imprecise estimates of the computing device's altitude, for example, may have life-or-death consequences for the user of the computing device since the imprecise altitude estimate can delay emergency personnel response times as they search for the user on multiple floors of a building. In less dire situations, imprecise altitude estimates can lead a user to the wrong area in an environment.

In order to expand coverage for location-determination capabilities (with vertical axis coverage) to new geographical areas, the deployment of a reference network of weather stations is typically required. This reference network serves as the backbone for gathering essential atmospheric data vital for various applications, including meteorological and environmental monitoring. However, the establishment of such a network entails significant financial investments, thereby posing a considerable challenge for organizations aiming to extend location-determination coverage to new territories.

A fundamental aspect of vertical axis coverage lies in accurately determining altitude. Conventionally, altitude determination relies on the utilization of barometric pressure sensors and temperature sensors, which measure atmospheric pressure and subsequently compute an estimated altitude based on established atmospheric models. However, this conventional approach is not without its limitations, particularly when aiming to circumvent the necessity or cost of deployment or extension of a dedicated reference network.

One of the primary challenges in utilizing pressure sensors for altitude calculation revolves around the dynamic nature of ambient pressure. Atmospheric pressure exhibits fluctuations throughout the day due to various factors such as weather patterns, temperature changes, and geographical influences. Consequently, pressure measurements alone cannot determine a user's absolute altitude at a floor-level resolution without using a reference network to correct for the factors listed previously.

Moreover, in the context of minimizing operational costs and power consumption, there arises a pressing need to optimize the location engine utilized for altitude determination. Conventional location engines often rely on heavy power draining queries to the computing device, resulting in heightened power consumption and decreased operational efficiency. Hence, there is a critical demand for innovative approaches that streamline the location determination process, ensuring minimal device queries for position calculations while maintaining high accuracy in altitude determinations.

Addressing these challenges requires a comprehensive understanding of atmospheric dynamics, sensor technologies, and algorithmic methodologies. Moreover, it necessitates the development of robust solutions capable of accurately estimating altitude without relying on an extensive reference network of weather stations. By surmounting these obstacles, organizations can significantly enhance their vertical axis coverage capabilities while simultaneously reducing operational costs and environmental impact.

### SUMMARY

In some examples, a system and/or method detects a pressure change based on pressure measurement data from a barometric pressure sensor of a computing device; determines a 2D location of the computing device; determines an altitude change of the computing device using the pressure change; determines a cumulative altitude offset value by adding the altitude change to a previous cumulative altitude offset value; and determines a terrain-based altitude of the computing device based on the 2D location and terrain data from a geodatabase; and determines an altitude of the computing device based on the terrain-based altitude and the cumulative altitude offset value.

In some examples, the system and/or method further determines a search area for the 2D location; obtains a maximum building height from the geodatabase based on the search area and the 2D location of the computing device for a building within the search area; determines there is a multistory building or a building with a height above a tall threshold value within the search area; determines that the altitude change is less than or equal to the expected terrain altitude change added to the maximum building height; and determines the cumulative altitude offset value by adding the altitude change to the previous cumulative altitude offset value.

In some examples, the system and/or method further determines a search area for the 2D location; determines that there is not a multistory building or a building with a height above a tall threshold value within the search area; and sets the cumulative altitude offset value to a reset value.

In some examples, the system and/or method further determines a search area for the 2D location; obtains a maximum building height from the geodatabase based on the search area and the 2D location of the computing device for a building within the search area; determines there is a multistory building or a building with a height above a tall threshold value within the search area; determines that the altitude change is not less than or equal to the expected terrain altitude change added to the maximum building height; determines that the altitude change is not within an acceptable excess altitude threshold value of the expected terrain altitude change added to the maximum building height; and sets the cumulative altitude offset value to a reset value.

In some examples, the system and/or method further determines a search area for the 2D location; obtains a maximum building height from the geodatabase based on the search area and the 2D location of the computing device for a building within the search area; determines there is a multistory building or a building with a height above a tall threshold value within the search area; determines that the altitude change is not less than or equal to the expected terrain altitude change added to the maximum building height; determines that the altitude change is within an acceptable excess altitude threshold value of the expected terrain altitude change added to the maximum building height; and uses the maximum building height as the altitude change.

### BRIEF DESCRIPTION OF THE DRAWINGS

FIG. 1 is a simplified environment in which a barometric pressure sensor within a computing device can be used to determine an altitude of the computing device, in accordance with some examples.

FIGS. 2-6 show example simplified graphs of pressure measurements vs. time for use in the present disclosure, in accordance with some examples.

FIGS. 7-12 show example simplified flowcharts of processes for use in the present disclosure, in accordance with some examples.

FIG. 13 shows example simplified tables of altitude jumps and cumulative altitude jumps for use in the present disclosure, in accordance with some examples.

FIG. 14 shows simplified schematic diagrams of a transmitter, a computing device, and a server for use in the environment shown in FIG. 1, in accordance with some examples.

### DETAILED DESCRIPTION

The present disclosure enables the determination of the 3D (three-dimensional) location of a computing device (e.g., a mobile device, cell phone, smart phone, tablet computer, notebook computer, electronic gaming device, etc.) using pressure changes but without the need for a costly reference network of weather stations. Additionally, the present disclosure reduces overall power consumption by minimizing the time needed to determine the 2D location (i.e., latitude and longitude) of the computing device. Therefore, the present disclosure enables expansion of coverage for location-determination capabilities (including vertical axis) to new geographical areas more quickly, more efficiently, less expensively, and with less power consumption than can be done by conventional techniques that use a reference network. The present disclosure generally does this by using a geodatabase of terrain and building data augmented by a relative altitude difference (i.e., an altitude offset value) based on pressure measurements (or a relative difference between pressure measurements) by a barometric (i.e., atmospheric) pressure sensor of the computing device. In some examples, the geodatabase includes only terrain data. Additionally, a temperature lookup or temperature modeling may also be used to convert pressure measurements to altitude.

The present disclosure provides systems and methods that detect a situation in which the pressure sensor of the computing device indicates a significant pressure change (i.e., a positive or negative pressure jump) in the vicinity of the computing device over a predetermined range of time. This detection triggers the computing device to determine its 2D (two-dimensional or horizontal) location. Then the system uses the location to perform a 2D lookup of the altitude of the terrain at the location of the computing device in the geodatabase of terrain and building data. The system then augments the 2D lookup of the terrain altitude by adding a relative altitude difference based on an estimated altitude change that is indicated by or calculated from pressure sensor measurement data from the pressure sensor of the computing device. The relative altitude difference may be based on a single significant pressure change/jump (i.e., an altitude offset value) or a cumulative result of multiple significant pressure changes/jumps (i.e., a cumulative altitude offset value).

Since the system uses a relative altitude difference based on a relative pressure difference, the present disclosure harnesses the relative accuracy advantages of pressure sensors, thereby overcoming some of the limitations of conventional altitude determination methods that depend on absolute accuracy. The relative accuracy between any two or more pressure measurements is typically significantly higher than the absolute accuracy of a single pressure measurement. For example, the relative accuracy between two pressure measurements (i.e., the difference between the two measured pressure values compared to the difference between the actual pressures at the two measurement points) of a typical pressure sensor in a computing device may be on the order of about 5-10 Pa. On the other hand, the absolute accuracy of any single pressure measurement (i.e., the difference between the measured pressure value and the actual pressure at the measurement point) of the pressure sensor is commonly on the order of about 100 Pa, potentially ten times worse than the relative accuracy.

Additionally, in some examples, the system of the present disclosure needs to determine the location of the computing device only upon being triggered as mentioned above by the detection of a pressure jump. Compared to conventional altitude-determination techniques, this pressure-jump triggering feature can represent a significant improvement in or reduction of power consumption. This is because a query for a location determination by a location engine is generally a high drain on the battery or power source of the computing device, and conventional altitude-determination techniques typically have to determine location relatively frequently. By comparison, however, a triggering pressure jump in accordance with examples of the present disclosure is likely to occur relatively infrequently. Additionally, measurements by a barometric pressure sensor (e.g., to detect the pressure jump) typically consume relatively low power, so such measurements may be performed relatively frequently without a significant drain on the battery or power source of the computing device. By ensuring minimal location querying, therefore, the system helps to minimize operational costs and enhance the system's sustainability by conserving energy resources.

The benefits or advantages of the present disclosure are particularly significant in a situation where a user calls an emergency service such as 911 from within a high-rise office building during a life-or-death situation. In such a situation, a floor designator that indicates which floor of the building the user is on may be significantly more useful to the first responders or emergency personnel trying to reach the user as compared to receiving a raw estimated altitude value reported by the user's computing device. Therefore, the improved technique described herein for determining the altitude of the computing device (e.g., with better calibration of the pressure sensor therein or improved altitude estimation) can be combined with a technique for determining the floor most likely to correspond to the determined altitude (e.g., as described in US Patent Publication No. 2023/0384087), and thereby improve emergency service response times. (US Patent Publication No. 2023/0384087 is incorporated herein by reference as if fully set forth herein.) In this case, if the user is calling from within a multi-floor building, then the emergency 911 (e.g., E911) service would require the floor number in order to properly dispatch an emergency medical team to the correct floor. However, if the user cannot provide the floor number, then the E911 app on the computing device or a server must provide it, because correct knowledge of the floor number (or altitude of the computing device) can be critical for the emergency medical team to search for and find the user on the correct floor in a timely manner. Since the building is likely to be included in a geodatabase of terrain and building data, the present disclosure can aid in making the determination of the most likely floor or a more accurate range of floors.

Additionally, there are a wide range of useful software applications that operate on computing devices and that require knowledge of the altitude of the computing device to operate properly or effectively. In some examples, some such applications simply inform the user of the computing device of their current location, including their altitude, for whatever personal purpose the user might have or feel a need for. In a specific example, on the other hand, the user might want to use an app on the computing device to receive electronic discounts or special advertisements for a retail store upon entering the store. However, if the store is in a shopping mall that has more than one floor, then the app needs to know which floor the computing device is on in order to operate properly, i.e., the app requires knowledge of the altitude of the computing device so that it can compare this altitude with the altitudes of the floors and make a proper determination of whether the user is likely to be in the correct store. Since the shopping mall or the store could be included in the geodatabase of terrain and building data, the present disclosure can aid in making the determination of whether the user and computing device are in the correct store.

The examples in the previous paragraphs highlight the importance, even life-saving criticality, of a good altitude determination for a computing device in various situations. However, there is usually some amount of uncertainty in the determined altitude value. Given the importance of a proper altitude determination, it is necessarily of equal importance to provide the altitude value with a high degree of certainty (i.e., a low degree of uncertainty) or a good determination of the uncertainty. In the critical example given above, the emergency medical team can be provided with the likely floor number for the computing device and the user, but with a further level of likelihood of whether the user could be on the next floor above or below, so that the emergency medical team can know whether to expand their search for the user to these other floors. Use of relative pressure (which typically has a relative accuracy between measurements that is higher than the absolute accuracy of a single pressure measurement) in combination with a geodatabase of terrain and building data (rather than reference data from a reference network) can potentially significantly improve the search for the user.

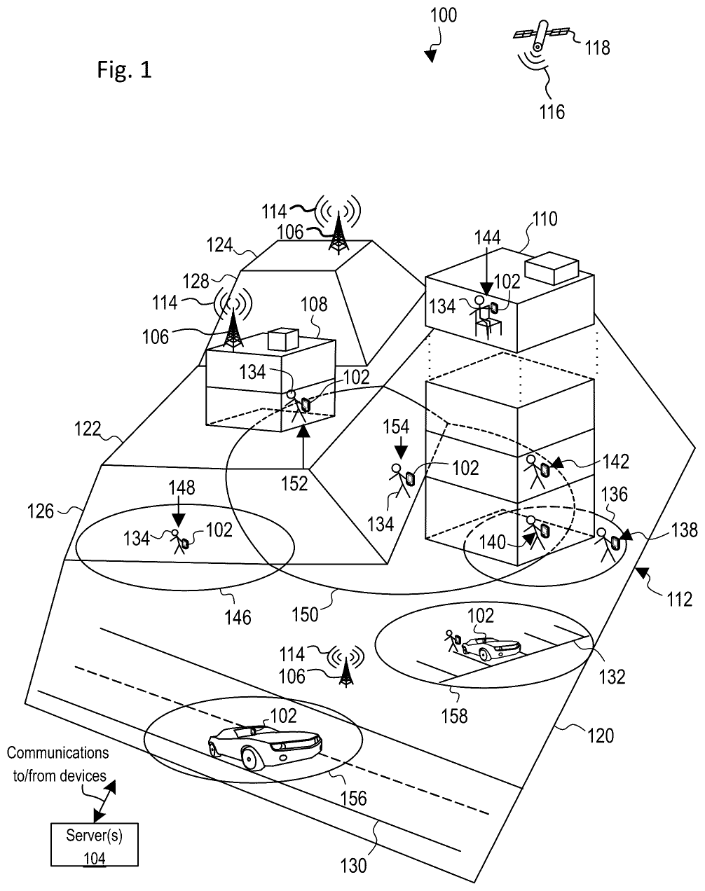

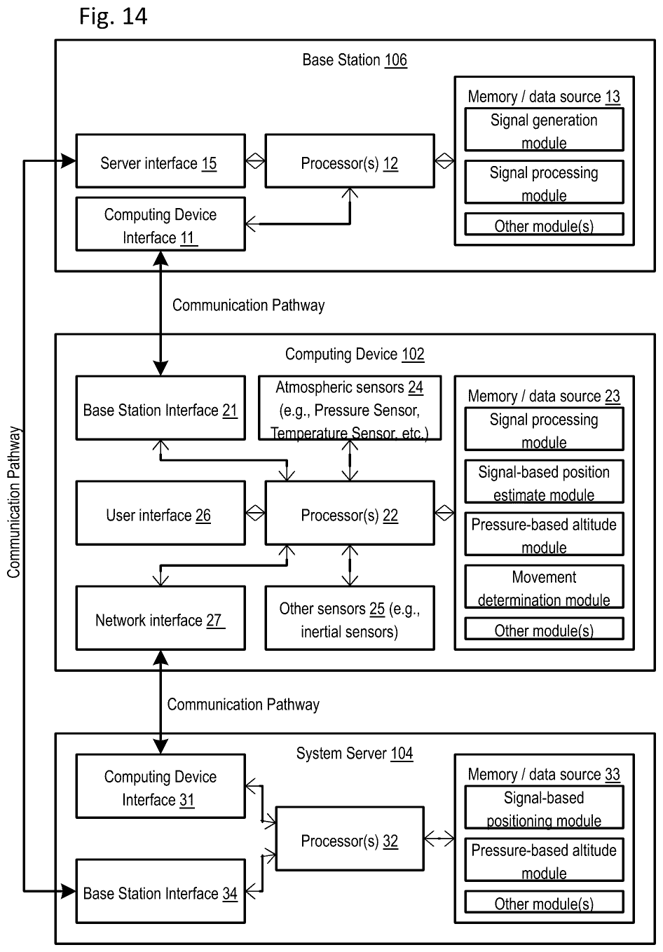

FIG. 1 shows a simplified operational environment 100 in which a barometric pressure sensor within a computing device 102 can be used to determine an altitude of the computing device 102, in accordance with some examples. The operational environment 100 is shown with several of the computing devices 102, one or more system servers 104, a network of terrestrial transmitters or locational base stations 106, example buildings 108 and 110, and an example terrain 112. The system server 104 exchanges communications with various devices, such as each computing device 102. Each of the base stations 106 and the computing device 102 may be located at different altitudes or depths that are inside or outside various natural or manmade structures (e.g., hilltops of the terrain 112 and/or the buildings 108 and 110), relative to different elevations throughout the terrain 112, as illustrated by examples in FIG. 1. Positioning signals 114 and 116 are transmitted from the base stations 106 and satellites 118 (e.g., part of a Global Navigation Satellite System (GNSS)), respectively, and are subsequently received by the computing device 102 using known transmission technologies. For example, the base stations 106 may transmit the signals 114 using one or more common multiplexing parameters that utilize time slots, pseudorandom sequences, frequency offsets, or other approaches, as is known in the art or otherwise disclosed herein. Examples of possible hardware, software, and data components in the base stations 106, the computing device 102, and the system server 104 are shown in FIG. 14, as described below. In particular, the computing device 102 may include atmospheric sensors (e.g., barometric pressure sensors and temperature sensors, as appropriate) for generating measurements of atmospheric conditions (e.g., atmospheric pressure and temperature) that are used to estimate an altitude of the computing device 102.

The terrain 112 is shown as having a low ground area 120 (e.g., a lowest elevation area), a middle ground area 122 (e.g., a middle elevation area on top of a low hill), a high ground area 124 (e.g., a high elevation area on top of a high hill), a first slope area 126 (e.g., a sloping ground from the low ground area 120 to the middle ground area 122), and a second slope area 128 (e.g., a sloping ground from the middle ground area 122 to the high ground area 124). The building 108 is shown as being located on a portion of the middle ground area 122, and the building 110 is shown as being located on a portion of the low ground area 120. In addition, a portion of a roadway 130 and a parking lot 132 are shown within the low ground area 120. Additionally, users 134 (i.e., people or customers) are shown carrying some of the computing devices 102 in different parts of the terrain 112, inside and outside of the buildings 108 and 110, or in vehicles. (For simplicity, not all of the users 134 or computing devices 102 are marked in FIG. 1 with a reference number.)

Within the terrain 112, several example 2D location areas are shown. Each 2D location area is determined by the server 104 or a corresponding computing device 102 based on the positioning signals 114 and 116 received by the computing device 102 from the base stations 106 and/or the satellites 118. Due to potential errors in the location determination, the computing device 102 can potentially be actually located at any point within the corresponding 2D location area.

As the computing device 102 moves through the terrain 112, the user 134 might carry the computing device 102 up or down the first slope area 126 or the second slope area 128 or from one floor to another floor within the building 108 or 110, thereby changing the altitude of the computing device 102. These changes in altitude usually result in significant corresponding changes in the pressure measurement values (i.e., the pressure “jumps”) generated from the pressure sensor in the computing device 102. In some examples, a “significant” pressure change/jump is generally considered herein to be at least a pressure difference corresponding to that of the pressure difference between two adjacent floors (e.g., greater than or equal to about 30 Pa), as would occur when changing at least one floor in the building 108 or 110. Additionally, when changing floors in the building 108 or 110, the “significant” pressure changes/jumps generally occur within at least an appropriate amount of time that it commonly takes a person to ascend or descend stairs or ride an elevator or escalator from one floor to the next, e.g., about 5 seconds to about 60 seconds. Therefore, the system generally analyzes multiple pressure measurements over time (i.e., a stream of pressure data) in order to detect a significant pressure change/jump within the appropriate amount of time. Upon detecting such a pressure change/jump, the system is triggered to determine the location of the computing device 102 and further to determine or recalculate the altitude of the computing device 102 and optionally the floor of the building 108 or 110 that the computing device 102 is on.

The determination of some of the 2D location areas shown in FIG. 1 could have been triggered by a detection of a significant pressure change/jump within the appropriate amount of time. In an example, a first 2D location area 136 may have been determined (based on positioning signals 114 or 116 received by the computing device 102 carried by the user 134) in response to such a pressure change/jump. The first 2D location area 136 is shown within the low ground area 120. A first portion of the first 2D location area 136 overlaps with a portion of the building 110 and a second portion of the first 2D location area 136 is on open terrain (i.e., not within a building or other structure). Since the corresponding computing device 102 can potentially be actually located at any point within the first 2D location area 136, it is possible that the user 134 and the computing device 102 could be outside any building on the open terrain (e.g., at location point 138) or inside the building 110 on any floor therein (e.g., on the ground/first floor at location point 140, on the second floor at location point 142, or on the top floor at location point 144, among others). Since the pressure change/jump is considered to be “significant” (as defined above) in this example, and since the first 2D location area 136 includes at least a portion that overlaps with the footprint of the building 110, the system determines that the computing device 102 is likely to be inside the building 110 and to have changed altitude from one floor to another. Alternatively, the 2D location radius or area can be scaled up by an appropriate factor (e.g., radius*C) that can increase/decrease the size of the area. Such scaling factor can be derived from lab testing and/or field testing and can be region and/or morphology specific. If multiple building footprints are detected within the location area 136, then there are multiple alternative approaches to determine which building the computing device 102 is likely to be in, such as closest distance to centroid of the location area 136, greatest overlap of the location area 136 with building footprint, etc. Whether the computing device 102 went up or down in altitude or between floors depends on whether the pressure change/jump was negative or positive, respectively. Additionally, which floor the computing device 102 is determined to have ended up on after the pressure change/jump further depends on the magnitude (which includes whether positive or negative) of the pressure change/jump, the conversion factor from pressure change/jump to altitude change/jump, and a starting altitude/floor prior to the pressure change/jump (e.g., based on a ground level from the geodatabase of terrain and building data or a previous altitude determination).

In another example, a second 2D location area 146 may have been determined in response to a significant pressure change/jump detected when the computing device 102 was at, for example, location point 148. The second 2D location area 146 is shown partially within the low ground area 120 and partially within the first slope area 126 (between the low ground area 120 and the middle ground area 122). Since a portion of the second 2D location area 146 overlaps the first slope area 126 and no portion of the second 2D location area 146 overlaps a building footprint, the pressure change/jump can potentially be explained by the user 134 and computing device 102 moving up or down the first slope area 126 of the terrain 112 if the altitude variation within the second 2D location area 146 is known from the geodatabase of terrain and building data to be sufficient to account for the pressure change/jump. Additionally, the system can typically determine the altitude of the computing device 102 using the location point 148 to perform the 2D lookup of the altitude of the terrain in the geodatabase of terrain and building data. Thus, the pressure change/jump is not necessarily needed to determine the altitude of the computing device 102 in this example. Nevertheless, the pressure change/jump can be used to confirm or refine the 2D location and altitude of the computing device 102 in conjunction with the terrain data from the geodatabase. Additionally, this situation can be used to reset the current altitude of the computing device, so that subsequent altitude determinations using pressure changes/jumps can be more certain or reliable.

In another example, a third 2D location area 150 may have been determined in response to a significant pressure change/jump. Different portions of the third 2D location area 150 overlap with the building 108, the building 110, the low ground area 120, the middle ground area 122, and the first slope area 126. Thus, the actual location of the computing device 102 may be within any of these areas or buildings, e.g., at location points 140, 142, or 144 within the building 110, location point 152 within the building 108, or location point 154 outside of any building, among others. Given the relative altitudes depicted in this example, if the magnitude of the pressure change/jump is at the low end, i.e., only about 30 Pa), then the pressure change/jump could potentially be explained by changing one floor in either of the buildings 108 or 110 or by moving up or down between the low ground area 120 and the middle ground area 122 across the first slope area 126. Thus, it might not be possible to properly attribute a pressure change to a floor change vs. a terrain change. In this case, the system may determine that the actual 2D location and altitude of the computing device 102 is uncertain. On the other hand, since the building 110 is shown as being significantly taller than the middle ground area 122 and the building 108, if the pressure change/jump is relatively large (e.g., indicative of an altitude change of two or more floors), then the system can determine that the computing device 102 is most likely inside the building 110. In this case, the system can determine which floor that the computing device 102 is on based on the pressure change/jump and a starting altitude/floor prior to the pressure change/jump (e.g., based on a ground level from the geodatabase of terrain and building data or a previous altitude determination).

As additional examples, a fourth 2D location area 156 and a fifth 2D location area 158 may have been determined in response to significant pressure changes/jumps. However, neither of these location areas are shown to overlap either a building or a terrain variation. The fourth 2D location area 156, for example, overlaps the relatively horizontal flat roadway 130 in the low ground area 120 with no nearby buildings. The fifth location area 158, for example, is within the low ground area 120 and overlaps the relatively horizontal parking lot 132 with no nearby buildings. Therefore, if a significant pressure change/jump triggered the determination of either of these location areas, then the system may further determine that a pressure anomaly or an error occurred, e.g., an incorrect or stale user location.

Additionally, since the system determines the location of the computing device after it has been triggered by a determination of a significant pressure change/jump, it is possible that the location of the computing device 102 before the significant pressure change/jump (the “prior location”) might not be known, e.g., as could happen for each of the examples described above, among others. Nevertheless, the prior location of the computing device 102 is needed to determine a starting altitude, so that the relative altitude difference can be added to it to determine the new altitude after the significant pressure change/jump. To estimate the prior altitude, in some examples, the system queries the geodatabase of terrain and building data to obtain terrain-based altitude data within a 2D search radius (or search area) for the 2D location. The prior location of the computing device 102 should have been somewhere within the 2D search radius. The 2D search radius “r” can be estimated, calculated or determined based on an estimated likely traversal speed (“max-speed”) and estimated elapsed time for the user 134 moving across the terrain (i.e., r=max-speed×time). Alternatively, the 2D search radius can be estimated based on a detected altitude change “alt-change” and an assumed or estimated elevation grade in the area of the 2D location (i.e., r=alt-change/grade), which might be preferred over the max-speed version as it can result in a smaller 2D search radius. In another alternative, the 2D search radius can be a fixed value or a fixed value that is typical for the morphology (e.g. 5 m for rural/suburban or 50 m for urban environments). In another alternative, the search area could be a polygon that includes the 2D location, not necessarily at the center of the polygon. In another alternative, the search area could be a pre-defined region like a set of city blocks or a boundary of a geographic region like a suburb or neighborhood region (e.g., “Wall Street”, “Midtown”, etc.). Then the 2D search radius or area is used to determine whether a terrain change could account for the altitude jump or significant pressure change/jump. If so, then the altitude of the computing device 102 can be determined based on the terrain data without using the significant pressure change/jump. However, if a terrain change could not account for the altitude jump or significant pressure change/jump, then the altitude of the computing device 102 can be determined based on the terrain data augmented by the significant pressure change/jump.

In some examples, if the resulting altitude determination (based on the altitude measurements) is provided in an absolute scale (e.g., height above ellipsoid (HAE)), then the system and method queries the geodatabase to obtain the terrain data with respect to the 2D location of the computing device 102 or in the vicinity of the computing device 102. For example, in the E911 use case, where altitude is reported in HAE, the HAE value of the ground-level terrain is determined based on the obtained terrain data. On the other hand, if the resulting altitude determination (based on the altitude measurements) is provided in a relative scale (e.g., height above terrain (HAT)), as in an enterprise use case such as for police or firefighters, then the system and method assumes the terrain in the vicinity of the computing device 102 is ground-level, i.e., 0 m. In this latter case, the terrain data from the geodatabase will not be necessary to report the altitude of the computing device 102 and does not need to be stored on a server (e.g., 104) or queried by the computing device 102. In some examples, this optimization can affect one of several sanity checks whereby the system and method determines the terrain change in the area of the computing device 102 to rule out hilly terrain to explain the altitude jump or significant pressure change/jump. In such a case, this check may be dropped or not performed.

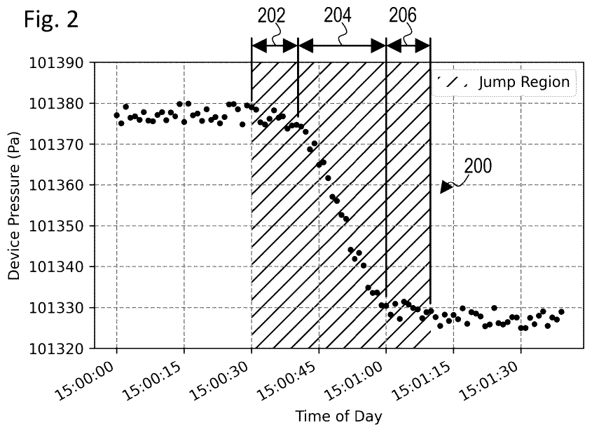

FIG. 2 shows an example simplified graph 200 of pressure measurements vs. time for use in the present disclosure, in accordance with some examples. The graph 200 illustrates an example situation that is appropriate for using the present system and method. Multiple simulated pressure measurements recorded over time show that a first (initial) portion 202 of the pressure measurements (collected during a first time period) are initially between about 101375 Pa and 101380 Pa. A second (transitional/middle) portion 204 of the pressure measurements (collected during a second time period that occurs almost immediately after the first time period) show a steady decrease over a period of about 20 seconds (from about time point 15:00:40 to about time point 15:01:00). A third (ending) portion 206 of the pressure measurements (collected during a third time period that occurs almost immediately after the second time period) end between about 101325 Pa and 101330 Pa. This pressure data satisfies six identified triggering criteria (described below) for determining whether a significant pressure change/jump has occurred so that the system and method of the present disclosure can be triggered. In some examples, any appropriate number of the criteria may be satisfied in order to trigger the system and method, e.g., six, five, four, three, two or one of the criteria, depending on empirical results.

A first criterion (stable beginning criterion) is that the pressure measurements preferably start relatively stable (e.g., a variation within a “beginning stable pressure threshold” range of about 5-10 Pa, inclusive, or less or a spread around a central tendency within about 3-5 Pa) during a period of time (i.e., the first time period) sufficiently long to establish such stability (e.g., a “beginning stable time threshold” range of about 5-10 seconds, inclusive). The first portion 202 of the pressure measurements satisfies this criterion, because these pressure measurements vary by only about 5 Pa (i.e., are within the beginning stable pressure threshold range) within a time period (i.e., the first time period) of about 10 seconds immediately before the second portion 204 occurs. This criterion helps to ensure that the computing device 102 was most likely on a relatively horizontally flat plane, such as a floor of a building, at the start of the pressure change/jump and not in a volatile pressure situation such as in a fast-moving vehicle.

A second criterion (stable ending criterion) is that the pressure measurements preferably end relatively stable (e.g., a variation within an “ending stable pressure threshold” range of about 5-10 Pa, inclusive, or less or a spread around a central tendency within about 3-5 Pa) during a period of time (i.e., the third time period) sufficiently long to establish such stability (e.g., an “ending stable time threshold” range of about 5-10 seconds, inclusive). The third portion 206 of the pressure measurements satisfies this criterion, because these pressure measurements vary by only about 5 Pa (i.e., are within the ending stable pressure threshold range) within a time period (i.e., the third time period) of about 10 seconds immediately after the second portion 204 occurs. This criterion helps to ensure that the computing device 102 was most likely on another relatively horizontally flat plane, such as another floor of the building, at the end of the pressure change/jump and not in a volatile pressure situation such as in a fast-moving vehicle.

A third criterion (transition duration criterion) is that the duration of the pressure change/jump is within a reasonable period of time commensurate with the amount of time that it typically takes for a person/user to move from a floor of a building to a different floor (up or down) of the building, e.g., about 5-60 seconds, inclusive (i.e., a “transition duration threshold” range). The second portion 204 of the pressure measurements satisfies this criterion, because the change or jump in the pressure values occurs over a time period (i.e., the second time period) of about 20 seconds (i.e., the time period between the first portion 202 and the third portion 206 of the pressure measurements is within the transition duration threshold range). This criterion helps to ensure that the pressure change/jump was a simple straightforward transition between two altitudes/floors. It is possible that a user could change floors more slowly, i.e., taking longer than 60 seconds, but due to potential uncertainties or ambiguities in the pressure data, these situations are filtered out by this criteria. Additionally, the transition duration threshold range may be dynamic or changeable, e.g., based on time of day or weather patterns.

A fourth criterion (transition magnitude criterion) is that the magnitude of the pressure change/jump is at least the typical pressure difference between two adjacent floors, e.g., greater than or equal to about 30 Pa (i.e., a “magnitude threshold”). The first portion 202 and the third portion 206 of the pressure measurements satisfy this criterion, because the difference between the average pressure values thereof is about 50 Pa (i.e., greater than or equal to the magnitude threshold), thereby indicating that the altitude/floor change was at least one floor and possibly two, depending on heights of each floor of the building. Stated another way, the second portion 204 of the pressure measurements satisfies this criterion, because the difference between the starting pressure value thereof and the ending pressure value thereof is greater than or equal to the magnitude threshold. This criterion helps to ensure that the system and method herein are not triggered when it is unlikely that the computing device 102 has actually moved between two floors, such as when it might have changed altitude by moving across a variable terrain or the pressure sensor has malfunctioned.

A fifth criterion (transition rate criterion) is that the rate of the pressure change/jump is physically realistic for a person/user moving between floors by stairs, elevator or escalator, e.g., less than or equal to about 30 Pa/second (i.e., one floor per second for elevator) and greater than or equal to about 30 Pa/minute (i.e., one floor per minute for stairs), i.e., within a “rate threshold” range of about 0.5-30 Pa/second or 30-1800 Pa/minute, inclusive. The second portion 204 of the pressure measurements satisfies this criterion, because the magnitude of the pressure change/jump (i.e., the difference between the first portion 202 and the third portion 206) is about 50 Pa and the duration of the pressure change/jump (i.e., the time of the second portion 204) is about 20 seconds, so the rate of the pressure change/jump is about (50 Pa÷20 seconds) 2.5 Pa/seconds (i.e., within the rate threshold range). This criterion helps to ensure that the computing device 102 is likely to have actually changed altitude/floors with the user, rather than having been dropped or thrown, or when the available data is too sparse or consecutive pressure measurements have too large of a difference to be reliable.

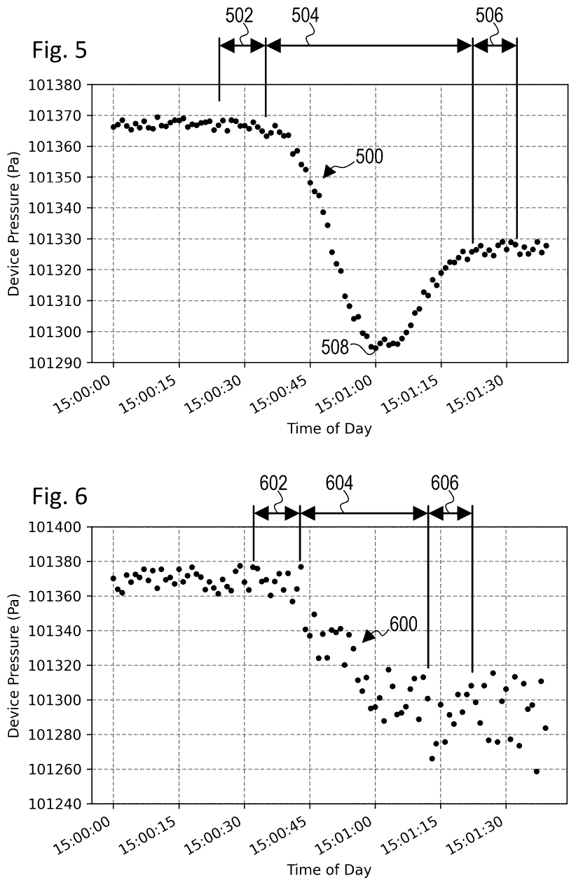

A sixth criterion (overall variation criterion) is that the magnitude of the overall variation of the pressure measurements throughout the transitional/middle (second) portion of the pressure measurements does not exceed or is equal to the magnitude of the total range of the pressure change/jump from the initial (first) portion to the ending (third) portion of the pressure measurements (i.e., the difference between the average pressure measurement values of the initial portion and the ending portion). The graph 200 satisfies this criterion, because the overall variation of pressure measurement values of the second portion 204 does not exceed or is equal to the difference between the average pressure measurement values of the first portion 202 and the third portion 206. This criterion helps to ensure that the pressure change/jump is most likely due to changing floors in a building, rather than to odd pressure fluctuations due to some other type of situation, such as traveling in a fast-moving vehicle. An example of this is illustrated by FIG. 5.

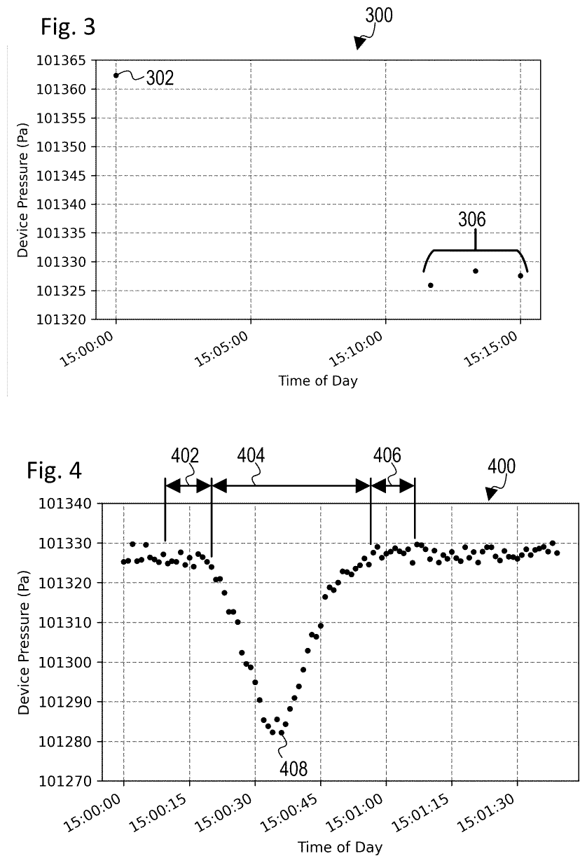

FIGS. 3-6 illustrate situations that do not satisfy the triggering criteria described above, so it is unlikely or uncertain that the computing device 102 has actually changed floors in a building, and the system and method should not be triggered in these situations.

As an example, FIG. 3 shows a simplified graph 300 of pressure measurements vs. time. However, the measurement data is too sparse and insufficient for use with the system and method herein. In particular, there is only one data point for the initial portion 302 of the pressure measurements. A single data point is insufficient for being able to determine whether the stable beginning criterion is satisfied, because it is impossible to know whether any other pressure measurements would have been within the beginning stable pressure threshold range of each other. Thus, the initial portion 302 of the pressure measurements must include at least a minimum number of data points in order to reliably determine whether the stable beginning criterion is satisfied. In some examples, this minimum number might be at least 5 points that are all within 10 Pa of a central tendency (mean or median for example) for data collected about every 1 second or at least 2-3 points that are all within 10 Pa of a central tendency for data collected about every 5 seconds or other appropriate number of data points within an appropriate time period. In this manner, multiple measurements within a reasonable amount of time help reinforce an acceptable level of confidence that the altitude of the computing device 102 is stable. Additionally, there are only three data points for the ending portion 306 of the pressure measurements. Although these data points are within the ending stable pressure threshold range of each other, the ending portion 306 of the pressure measurements must still include at least a minimum number of data points in order to reliably determine whether the stable ending criterion is satisfied. Furthermore, there is about a 12 minute time period between the initial portion 302 of the pressure measurements and the ending portion 306 of the pressure measurements, which is well outside the transition duration threshold range, so the transition duration criterion is not satisfied. In addition, the magnitude of the pressure change/jump is shown as about (35 Pa÷12 minutes) 2.9 Pa/minute, which is well outside the rate threshold range, so the transition rate criterion is not satisfied. Therefore, four of the six criteria are not satisfied, so this example is not suitable for use with the system and method herein.

As another example, FIG. 4 shows a simplified graph 400 of pressure measurements vs. time. However, in this example, an initial portion 402 and an ending portion 406 of the pressure measurements are at about the same range of pressure values, so the transition magnitude criterion is not satisfied. Additionally, since the initial portion 402 and the ending portion 406 of the pressure measurements are about the same, the transition rate criterion is not satisfied. Furthermore, the overall variation appears to be about 45-50 Pa (i.e., from a most extreme pressure measurement 408 to either the initial portion 402 or the ending portion 406) and the difference between the pressure measurement values of the initial portion 402 and the ending portion 406 is about 0 Pa, so the overall variation criterion is not satisfied. Therefore, three of the six criteria are not satisfied, so this example is not suitable for use with the system and method herein. Additionally, the pressure measurement variation of a relatively sudden decrease in pressure during the transitional/middle portion 404 of the pressure measurements followed by a return to about the same initial pressure values is commonly associated with pressure anomalies that can occur when the computing device 102 is traveling in a fast-moving vehicle, so a change between floors in a building is unlikely to have occurred in this example. Nevertheless, the example of FIG. 4 could represent a situation in which a user carried the computing device 102 to another floor and then almost immediately returned to the original floor. In such a situation, it would be unnecessary to make a new altitude determination, so it is still acceptable to determine that this situation is not suitable for use with the system and method herein.

As another example, FIG. 5 shows a simplified graph 500 of pressure measurements vs. time. However, in this example, the overall variation appears to be about 70-75 Pa (i.e., from a most extreme pressure measurement 508 to an initial portion 502) and the difference between the pressure measurement values of the initial portion 502 and an ending portion 506 is about 40 Pa, so the overall variation of the pressure measurements throughout the transitional/middle portion 504 of the pressure measurements exceeds the magnitude of the total range of the pressure change/jump from the initial portion 502 to the ending portion 506 of the pressure measurements. Therefore, the overall variation criterion is not satisfied. Thus, one of the criteria is not satisfied, so if all six of the criteria have to be satisfied, then this example is not suitable for use with the system and method herein; but if five of the criteria have to be satisfied or if the overall variation criterion is not a consideration, then this example is potentially suitable for use with the system and method herein, and the significant pressure change/jump between the initial portion 502 and the ending portion 506 can be used in the system and method herein. An additional consideration is that the pressure measurement variation of a relatively sudden decrease in pressure during the transitional/middle portion 504 of the pressure measurements followed by a partial return back toward the initial pressure values is commonly associated with pressure anomalies that can occur when the computing device 102 is traveling in a fast-moving vehicle on a roadway that had a change in altitude, so a change between floors in a building might be unlikely to have occurred in this example. This criterion could potentially exclude a situation in which the computing device is in a vehicle that is driving up a parking structure, even though that is similar to changing floors in a building. On the other hand, this pressure measurement variation could also occur in a situation where the user carried the computing device 102 up two floors in a building and then immediately back down one floor. Given the two possible scenarios that could account for this pressure measurement variation, the system should determine that it is uncertain whether this situation is suitable for use with the system and method herein. In some examples in which this situation occurs, therefore, the system determines not to use such pressure measurements in the system and method herein.

As another example, FIG. 6 shows a simplified graph 600 of pressure measurements vs. time. In this example, the graph 600 has some similarities to the graph 200 of FIG. 2 in that the graph 600 starts at a higher pressure in an initial portion 602, decreases in a transitional/middle portion 604, and ends at a lower pressure in an ending portion 606. However, the data points throughout the graph 600 vary more (with respect to the pressure value) than those of the graph 200. The data points of the initial portion 602, for example, vary by about 20 Pa (e.g., from about 101360 Pa to about 101380 Pa), which is greater than the above-mentioned beginning stable pressure threshold range of about 5-10 Pa. Thus, the initial portion 602 does not satisfy the stable beginning criterion. Additionally, the data points of the ending portion 606 are vary by about 60 Pa (e.g., from about 101260 Pa to about 101320 Pa), which is greater than the above-mentioned ending stable pressure threshold range of about 5-10 Pa. Thus, the ending portion 606 does not satisfy the stable ending criterion. Therefore, two of the six criteria are not satisfied, so this example is not suitable for use with the system and method herein. This criterion could exclude a situation in which the pressure sensor or the environment happens to be relatively noisy, e.g., in a fast moving vehicle that is changing terrain altitudes when a window thereof is down.

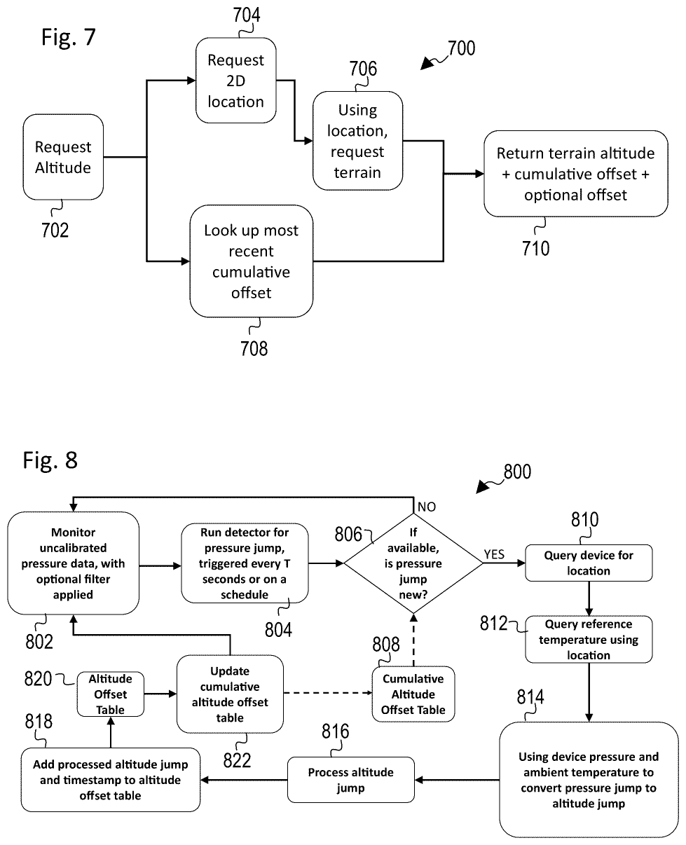

FIG. 7 shows an example simplified flowchart of a process 700 for the system to request or determine the current altitude of the computing device 102, in accordance with some examples. The process 700 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

The process 700 starts when the system receives an altitude request (at 702) triggered when the system detects a significant pressure change/jump in the pressure measurement data of the computing device 102. The system then requests or determines (at 704) the 2D location of the computing device 102, which is determined based on the positioning signals 114 and/or 116. Using the 2D location, the system then requests or determines (at 706) the terrain data for the 2D location from the geodatabase of terrain and building data in order to determine the terrain-based altitude of the 2D location. Before, after, or in parallel with 704 and 706, the system also looks up (at 708) the most recent cumulative offset (i.e., a current cumulative altitude offset value). The system then determines or calculates the altitude of the computing device 102 as the sum of the terrain-based altitude, the current cumulative altitude offset value (i.e., the relative altitude difference), and an appropriate optional offset value. (Wherein the appropriate optional offset value may be about 1 m to account for the computing device 102 likely being held by the user approximately 1 m above the ground/floor level most of the time.) The system returns (at 710) the altitude of the computing device 102 to whatever process or application (running on the computing device 102) that requested the altitude.

FIG. 8 shows a simplified flowchart of an example process 800 for the system to determine the result of each significant pressure change/jump (i.e., the altitude offset values) and determine or calculate the cumulative altitude offset value, in accordance with some examples. The process 800 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

Before the process 800 is performed to determine the cumulative altitude offset value, it may be assumed that the cumulative altitude offset value has been reset to an initial value, e.g., 0.0 meters or a non-numerical character that indicates that the altitude offset used should be 0.0 m. There may be several situations in which the cumulative altitude offset value is reset. For example, if the computing device 102 or the server 104 were to determine that the computing device 102 had been powered down or off during an inactive mode (or at any other time), then the a reset value is inserted into an altitude offset table (which will cause the count for the cumulative altitude offset value in a cumulative altitude offset table to be reset, e.g., to 0.0 meters). In another example, if the computing device 102 or the server 104 were to determine that the inactive time period had occurred for longer than an “inactive” threshold time period (e.g., 5-7 days or other appropriate time period) then the reset value is inserted into the altitude offset table, thereby causing the cumulative altitude offset value to be reset to the reset value (or 0.0 meters) in the cumulative altitude offset table. In yet another example, if the computing device 102 or the server 104 were to determine that the 2D location of the computing device 102 has changed significantly after a most recent prior altitude query, then the reset value is inserted into the altitude offset table, thereby causing the cumulative altitude offset value to be reset to the reset value (or 0.0 meters). In a further example, if the computing device 102 or the server 104 were to determine that the location of the computing device 102 has changed unphysically (meaning a location change that should be impossible or improbable, such as if the speed or position difference divided by the time difference has exceeded a change threshold value, e.g., 1000 km per hour or other unlikely speed value), then the reset value is inserted into the altitude offset table, thereby causing the cumulative altitude offset value to be reset to the reset value (or 0.0 meters). In another example, if the computing device 102 were rebooted or restarted after calculations for the cumulative altitude offset value had begun, then the reset value is inserted into the altitude offset table, thereby causing the cumulative altitude offset value to be reset to the reset value (or 0.0 meters). Other reset situations are described herein.

Upon starting, the process 800 monitors (at 802) pressure measurement data (e.g., uncalibrated) from the pressure sensor at appropriate intervals (e.g., about every 1-10 seconds). Additionally, one or more optional filters may be applied to the pressure measurement data. For example, an optional outlier filter may be applied to the pressure measurement data to remove potentially erroneous or outlying pressure measurements that could affect the determination of the altitude change/jump, e.g., measurements that are more than about three standard deviations away or above 95% or below 5% of the overall data. In another example, an optional smoothing filter may be applied to the pressure measurement data. In this manner, the system collects the multiple pressure measurements over time, e.g., as shown in the graphs of FIGS. 2-6. Furthermore, in some examples, the pressure measurement data can be monitored or sampled at different rates within a specified time period, such as every second, or every five seconds, or any 5 samples within 10 seconds; however, a maximum sampling time threshold value should be used for the specified time period to ensure monitoring of the pressure values within reasonable time periods, such as about 10 seconds.

In some cases, however, in order to minimize constant or too-frequent pressure monitoring, the system and method optimize the monitoring by taking advantage of a sensor hub of the computing device 102. The sensor hub aggregates different sensors (e.g., accelerometer, gyroscope, light, etc.) on the computing device 102 and determines if the computing device 102 is in one of various states such as “active”, “inactive”, “sleep”, among others. If the device is in the sleep state, then the system and method refrain from or stop monitoring pressure since the computing device 102 should not be in motion in this state. On the other hand, if the device is woken up to the active state, then the system and method start monitoring the pressure again. In some examples, readings from individual sensors are substituted to estimate the state of the computing device 102, such as exceeding a threshold on the accelerometer or light sensors. If the computing device 102 becomes inactive, the system and method halt monitoring immediately or continue monitoring up to a threshold wait time or number of pressure samples (e.g., 1 min or 10 samples).

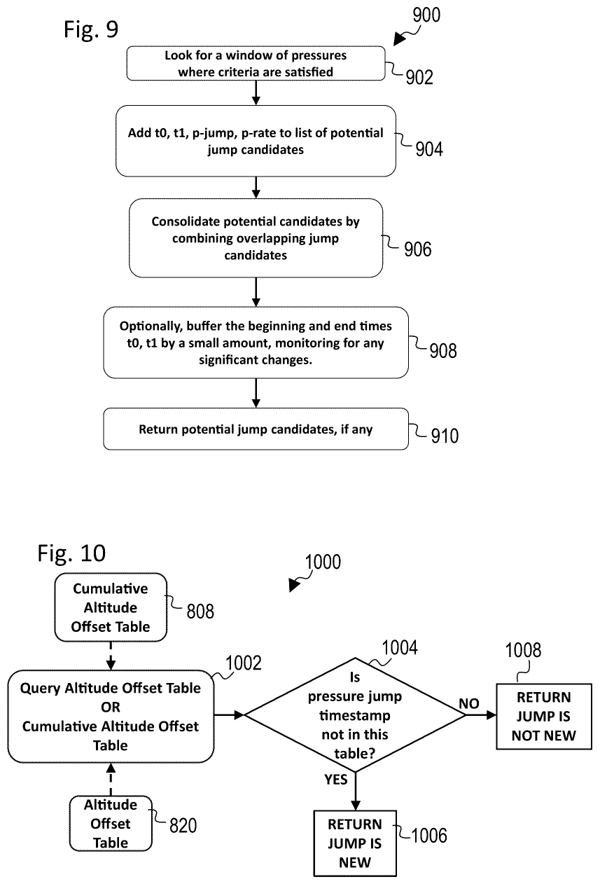

The process 800 then runs (at 804) a detector process to detect or determine whether a significant pressure change/jump has occurred, or one or more have occurred. An example of the detector process is shown in FIG. 9 and described below. In some examples, the detector process is triggered or run every T seconds (e.g., about 10-120 seconds) or on a set schedule. In this manner, the system detects whether a significant pressure change/jump has occurred (and satisfies an appropriate number of the above-described criteria). If the time T between the points at which the detector is triggered is too short, then too little of the jump might be captured and the jump magnitude would be underestimated; but if it is too long, then significant lag might be introduce in the altitude offset calculation.

When the occurrence of a significant pressure change/jump is determined, the process 800 then determines (at 806) whether the significant pressure change/jump is new or has already been processed or analyzed. If it is available, this determination or check is based on data stored in the cumulative altitude offset table 808 that shows each of the cumulative altitude offset values that have been calculated or determined. An example of a process for performing this determination is shown in FIG. 10 and described below. If the significant pressure change/jump is determined not to be new, then the process 800 returns to 802 to continue monitoring the pressure measurements. If the significant pressure change/jump is determined to be new, then the process 800 proceeds to 810 to begin the analysis of the significant pressure change/jump.

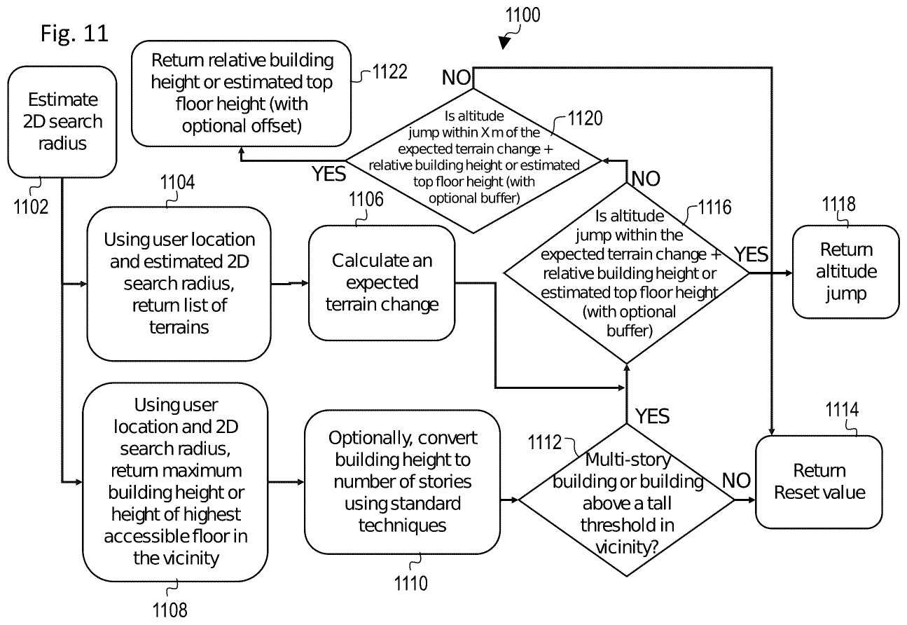

At 810, the process 800 queries the computing device 102 to obtain its 2D location. The process 800 then queries or obtains (at 812) a reference ambient temperature for the 2D location, e.g., a temperature from a weather service or an assumed temperature based on time of day and time of year, a weather prediction model, an assumed temperature for a day of the year, an assumed temperature for a given region, or any other appropriate temperature assumption. The process 800 then converts (at 814) the significant pressure change/jump to an altitude change/jump using or based on the value of the significant pressure change/jump and the ambient temperature. The process 800 then runs (at 816) an additional process for analyzing the altitude change/jump (or the significant pressure change/jump) to determine an appropriate value to use for the altitude change/jump. An example process for this analysis is shown in FIG. 11 and described below.

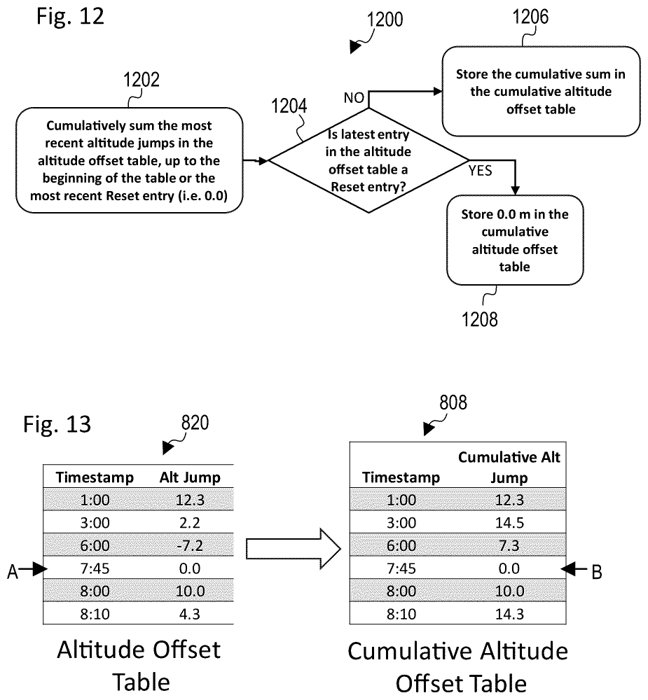

The process 800 then stores or adds (at 818) the new processed altitude change/jump value and a timestamp therefor (e.g., indicating a start time of the jump, an end time of the jump, an average of the start time and end time, or another appropriate time point within the jump) to the altitude offset (or jump) table 820. The process then updates (at 822) the cumulative altitude offset table 808 by adding the new altitude change/jump value to the current cumulative altitude offset value to obtain a new cumulative altitude offset value as described below with respect to FIG. 12. In this manner, the cumulative altitude offset value is increased when the new altitude change/jump value is positive and is decreased when the new altitude change/jump value is negative, thereby maintaining the current cumulative altitude offset value as a rolling cumulative sum of the altitude changes/jumps since the last point at which the altitude was reset, e.g., by a terrain altitude lookup or a conventional altitude determination using a reference network. The process 800 then returns to 802 to continue monitoring the pressure measurements.

FIG. 9 shows a simplified flowchart of an example of the detector process (above at 804) to detect or determine whether a significant pressure change/jump has occurred (or one or more have occurred), in accordance with some examples. The process 900 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

At 902, the process 900 analyzes the latest collection of pressure measurement data to look for a window of pressure measurements where the criteria are appropriately satisfied, as described above. In this analysis, the process 900 determines a beginning time t0, an end time t1, a magnitude (including whether positive or negative) of the total range of the pressure change/jump from the initial portion to the ending portion (p-jump), and a magnitude (including whether positive or negative) of the detected rate of change (p-rate) of the significant pressure change/jump. At 904, the process 900 adds the pressure change/jump (e.g., characterized by the t0, t1, p-jump, and p-rate) to a list of potential jump candidates or pressure change candidates that includes other pressure changes/jumps. At 906, the process 900 uses this data to consolidate the potential jump candidates in the list by combining jump candidates that overlap in time or are adjacent to each other in time. The resulting combined pressure change/jump is used as the pressure change/jump in the process 800 in FIG. 8. In some examples, such consolidation can be done by selecting the jump candidate with the largest rate of change, consolidating other nearby jumps into it, moving on to repeat this with the jump with the next largest rate of change that exists after consolidation, and so on until all jumps are processed. Alternatively, in some examples, the jump with the largest magnitude is selected, other jumps are consolidated into it, and then move on to repeat this with the jump with the next largest magnitude that exists after consolidation, and so on until all jumps are processed. Alternatively, rate-of-change example can be alternated with the magnitude example, and so on until all jumps are processed. In some examples, the process 900 optionally buffers (at 908) the beginning time t0 and/or the end time t1 (e.g., moving the beginning time to backward and/or the end time t1 forward) by a relatively small amount so as to be able to monitor for any significant changes in the pressure measurements and to provide a potentially more accurate estimation of the initial portion and the ending portion which can help resolve situations that appear to result in an altitude that is borderline between two floors. If one or more potential jump candidates are detected by the process 900, then the process 900 returns (at 910) the potential jump candidates to 804 in the above process 800. If more than one potential jump candidate is returned, then each of them is used as the pressure change/jump in separate performances of the process 800. Alternatively, only the top N potential jump candidate(s) is/are used in a performance of the process 800, where N can be any appropriate number, e.g., 5-10.

FIG. 10 shows a simplified flowchart of an example of a process 1000 for determining if a significant pressure change/jump is new (above at 806), in accordance with some examples. The process 1000 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

Upon starting, the process 1000 queries (at 1002) the cumulative altitude offset table 808 or the altitude offset table 820 for an existing entry in either table with the same pressure jump timestamp as (or a timestamp within a “time threshold” value of) the significant pressure change/jump that is being analyzed. If the pressure jump timestamp of the significant pressure change/jump that is being analyzed is not in either table (i.e., the pressure jump timestamp is not the same as, or is not within the time threshold value of, the existing entry), as determined at 1004, then the process 1000 returns (at 1006) a positive or “yes” response (to 806) that the significant pressure change/jump is new. On the other hand, if the pressure jump timestamp of the significant pressure change/jump that is being analyzed is in either table (i.e., the pressure jump timestamp is the same as, or is within the time threshold value of, the existing entry), as determined at 1004, then the process 1000 returns (at 1008) a negative or “no” response (to 806) that indicates that the significant pressure change/jump is not new. In some examples, both tables are checked and if the jump timestamp is in one but not the other, then the process 1000 returns the negative or “no” response that indicates the significant pressure change/jump is not new. Thus, the determination of whether the current significant pressure change/jump is new is based on whether an existing entry in the cumulative altitude offset table 808 or the altitude offset table 820 has a similar timestamp.

FIG. 11 shows a simplified flowchart for an example process 1100 for analyzing the altitude change/jump (or the significant pressure change/jump) to determine an appropriate value to use for the altitude change/jump (above at 816) or to reset the cumulative altitude offset value, in accordance with some examples. The process 1100 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

Upon starting, at 1102, the process 1100 estimates the 2D search radius described above. The process 1100 then branches to steps 1104 and 1108, e.g., 1104 and 1106 can be done in parallel (as shown) or in series with steps 1108, 1110 and 1112. At 1104, the process 1100 obtains or returns a list of terrains (which may include a range of terrain data) from the terrain data of the geodatabase for the 2D location area or based on the 2D location of the user and the computing device 102 and the estimated 2D search radius. At 1106, the process 1100 also determines or calculates (based on or using the list of terrains or the terrain data) an expected terrain altitude change. This calculation may, for example, look for the max-min of terrain, 5%-95% of terrain, or for following possible paths on a map (e.g., within the 2D search radius), to estimate likely terrain changes which may be defined by roads, trails, or other paths. At 1108, the process 1100 obtains or returns a maximum relative building height for the tallest building (or relative height of highest accessible floor, which may include the roof of the building) from the geodatabase of terrain and building data in the vicinity of the 2D location area or based on the 2D location and the estimated 2D search radius or area (optionally with a buffer taking into account the computing device 102 being held by the user above the ground/floor or noise effects or other contributions to the error budget of the pressure sensor). In other words, the height of the tallest building in the search area is obtained or determined. At 1110, the process 1100 optionally converts the relative building height to a number of stories/floors using standard techniques.

At 1112, the process 1100 determines whether there is a multistory building or a building that is above or taller than a “tall threshold” value (as obtained at 1108 or based on building data from the geodatabase) in the vicinity of the 2D location or within the 2D location area or the estimated 2D search radius as indicated by data from the geodatabase of terrain and building data. If not, then it is apparent that the user and the computing device 102 should be on the ground level indicated by the terrain altitude obtained from the geodatabase of terrain and building data. Thus, the appropriate value to use for the altitude change/jump returned (at 1114) to 816 in FIG. 8 should be a reset entry or value, which causes a reset entry to be entered into the altitude offset table 820 and resets the cumulative altitude offset value to the reset value (or 0.0 m), so that the most recent entry in the cumulative altitude offset table 808 is the reset value and an altitude determined by the process 700 in FIG. 7 going forward would not be augmented by a pressure/altitude jump. The reset entry also ensures that the accumulation of erroneous data from poor-quality cumulative altitude offsets are not continued to be carried forward to subsequent calculations that would result in unreliable altitude determinations. Such erroneous data is typically due to an incorrect 2D location but could be due to a transient error in the barometric pressure sensor. On the other hand, if there is a multistory building or a building that is above or taller than the tall threshold value in the vicinity as determined at 1112, then the process 1100 proceeds to 1116.

In some alternatives, for devices that require minimal user intervention and are called upon only sporadically for an altitude determination, such as an E911 call, monitoring for floor changes is used for maintaining accuracy. However, for the police/firefighter use case, the system and method may further minimize monitoring by prompting for user interaction with the computing device 102 prior to use. In such a case, the system and method prompt the user to input a manual reset before entering a building, so that the altitude or relative altitude of the computing device 102 is aligned to the ground-level (i.e., 0 m HAT or a nominal HAE value, plus any offset due to holding the device in the user's hand or belt). In other words, the manual reset is an event or trigger that resets the cumulative altitude offset value to the reset value (or 0.0 meters) and signals the start of the pressure monitoring and outputting or generating of the height relative to that trigger or reference point (HARP-Height Above Reference Point). Additionally, the system and method may prompt the user to manually enter the building characteristics into the computing device 102 (which are then sent to the server 104), e.g., “this building I'm entering is 50 m tall or 15 stories tall” or “I'm at 123 Main St.” and the building data is queried from the building data of the geodatabase using the address. Additionally, the computing device 102 could warn the user that if the subsequent detected jump up or jump down exceeds the building height extent, it could return either no value or a default or forced to a maximum or minimum value. In the use case of this paragraph, the process 1100 of FIG. 11 could be simplified to start at 1116 since the preceding steps would be superfluous.

At 1116, the process 1100 determines whether the altitude change/jump is within (or less than or equal to) the magnitude of the expected terrain altitude change (if any is determined at 1106) added to the maximum relative building height of the building or relative estimated height of the top (or highest accessible) floor (obtained at 1108) (optionally with a buffer taking into account the computing device 102 being held by the user about 1 m above the ground/floor or noise effects or other contributions to the error budget of the pressure sensor). If so, then this situation indicates the altitude change of the user and computing device 102 is likely due to movement between floors of the building and potentially a terrain altitude change relatively close to the building (e.g., as the user and computing device 102 entered or exited the building). Therefore, it is assumed that the significant pressure change/jump was correct or plausible, so the process 1100 returns (at 1118) the determined value for the altitude change/jump (to 816 in FIG. 8) to be used as the processed altitude change/jump. In some examples, the altitude change/jump can be augmented or changed (at 1118) based on the expected terrain altitude change (if any), such that the expected terrain altitude change is subtracted from the initially determined value for the altitude change/jump to arrive at a final determined value therefor, thereby ensuring that the altitude change/jump accounts for only the change within the building and not any change due to the terrain. In some examples, this augmentation is done only when the current 2D location of the computing device 102 is determined to be new, e.g., as indicated by the 2D location (within an appropriate location tolerance) having not been visited within a recent time period. Alternatively, in some examples, the determination at 1116 is based on only the maximum relative building height of the building or relative estimated height of the top (or highest accessible) floor and not on the expected terrain altitude change (if any). In some examples, this alternative is done when the location is not new (i.e., the location has been visited within the recent time period). On the other hand, if the determination at 1116 is negative (no), then the process 1100 branches to 1120.

At 1120, the process 1100 determines whether the altitude change/jump is within (i.e., less than or equal to) X meters (i.e., an acceptable excess altitude threshold value) of the magnitude of the expected terrain altitude change (if any is determined at 1106) added to the maximum relative building height of the building or relative estimated height of the top (or highest accessible) floor (obtained at 1108) (optionally with a buffer taking into account the computing device 102 being held by the user above the ground/floor or noise effects or other contributions to the error budget of the pressure sensor). (For example, the excess altitude threshold value may be about 10 m.) This generally determines whether the altitude change/jump is greater than or equal to a maximum value that should be expected (e.g., based on terrain, relative building height, and optional buffer); and even if it is greater than this maximum value, whether it is still considered realistic. Therefore, if the determination at 1120 is positive (yes), then it is assumed that the significant pressure change/jump should be limited to the relative height of the building or estimated relative height of the top floor or highest accessible floor (obtained at 1108) (optionally with a buffer taking into account the computing device 102 being held by the user above the ground/floor or noise effects or other contributions to the error budget of the pressure sensor), so the process 1100 returns (at 1122) the maximum relative building height of the building or estimated relative height of the top floor or highest accessible floor and the terrain change (if any) for the altitude change/jump (to 816 in FIG. 8) to be used as the processed altitude change/jump. Alternatively, in some examples, the determination at 1120 is based on only the maximum relative building height of the building or relative estimated height of the top (or highest accessible) floor and not on the expected terrain altitude change (if any), so the altitude change/jump will be limited (at 1122) to the relative height of the building or estimated relative height of the top floor or highest accessible floor (optionally with the buffer), without regard to any terrain change. In some examples, this alternative is done when the location is not new (i.e., the location has been visited within the recent time period). On the other hand, if the determination at 1120 is negative (no), then it is assumed that an error probably occurred, so the appropriate value to use for the altitude change/jump returned (at 1114) to 816 in FIG. 8 should be a reset entry or value along with a large uncertainty value.

In some examples, the expected terrain altitude change is not determined (i.e., 1104 and 1106 are not performed) and the magnitude of the expected terrain altitude change is not used at 1116 and 1120 (or the expected terrain altitude change is set to zero and used as described above). This may be done scenarios where the 2D location is unreliable, the geodata is unreliable, the terrain change measurement is unreliable, or other possible reasons.

In an alternative, if the determination at 1120 is positive (yes) more than (or equal to) a predetermined number of times (i.e., an error threshold number of times, e.g., 3 or more times) of performing the process 1100 in a row, then the process 1100 may branch to 1114 to return a reset entry or value to 816 in FIG. 8. As an example, a positive (yes) determination at 1120 results in incrementing a counter for the error threshold value, whereas a branch to 1114 or 1118 results in resetting this counter. Then when the counter is greater than or equal to the error threshold value, the process 1100 branches to 1114. This alternative may occur in a situation in which the barometric pressure sensor is faulty, e.g., it repeatedly indicates an altitude change/jump that is more than it should be, albeit not significantly more.

In another alternative, if the determination at 1120 is positive (yes) more than (or equal to) a predetermined number of times (i.e., a second error threshold value, e.g., 3 or more times) in a row, then the process 1100 may branch to 1118 to return the determined value for the altitude change/jump to 816 in FIG. 8. The effect of this alternative is to bypass, override or overrule the determinations at 1116 and 1120. This alternative may be appropriate, for example, if the data in the geodatabase is incorrect, such that the altitude change/jump is not in fact more than the data in the geodatabase indicates it should be or the 2D quality of the geodatabase lookup is incorrect and erroneously indicates that the 2D location of the computing device 102 is in a wrong building.

In another alternative, if the determination at 1120 is positive (yes), then before 1122, the process 1100 determines whether the altitude change/jump is in a positive or upward direction (e.g., up from a lower floor to an upper floor) or a negative direction (e.g., down from an upper floor to a lower floor). If the altitude change/jump is in a positive direction, then this would be in potential agreement with the determinations at 1116 and 1120, so the process 1100 proceeds to 1122. On the other hand, if the altitude change/jump is in a negative or downward direction, then there is a potential discrepancy with the determinations at 1116 and 1120, which indicate that the altitude change/jump is more than it should be (at 1116), albeit not too much more (at 1120). In this situation, an altitude change/jump in a negative direction should not have resulted in the “no” determination at 1116 and/or the “yes” determination at 1120, so there is a potential error. Thus, if the altitude change/jump is determined to be in a negative direction after 1120, then the process 1100 may branch to 1114 to return a reset entry or value to 816 in FIG. 8. Alternatively, if possible basement levels are taken into consideration, then the process 1100 may branch in this situation to a step that returns an estimated basement altitude of the lowest floor (with optional offset) of the building.

In another alternative, an anticipated cumulative altitude offset value is used instead of or in addition to the altitude change/jump at 1116 and/or 1120. Thus, at 1116, the process 1100 determines whether the anticipated cumulative altitude offset value (i.e., the current cumulative altitude offset value added to the altitude change/jump) is within the magnitude of the expected terrain altitude change and/or the relative building height. Then at 1120, the process 1100 determines whether the anticipated cumulative altitude offset value is within the acceptable excess altitude threshold value of the magnitude of the expected terrain altitude change and/or the relative building height. Additionally, the process 1100 reads or obtains the current cumulative altitude offset value at 1102 (or at any appropriate point before 1116 and/or 1120), so that it can be used at 1116 and/or 1120.

In another alternative, if the determination at 1112 is “no”, then the reset value is inserted into the altitude offset table 820, so that the most recent entry in the cumulative altitude offset table 808 becomes the reset value. However, in this alternative, the altitude change/jump is also processed through 1116-1122, which is likely to result in the processed altitude change/jump also being inserted into the altitude offset table 820 and the most recent entry in the cumulative altitude offset table 808 subsequently becoming the processed altitude change/jump immediately after the reset value.

In some examples, the following check can be done independently of, or in combination with, the process 1100 of FIG. 11. This check involves querying a pressure feed from a weather service (or other atmospheric pressure service) and measuring the distribution of reference pressures (e.g., max-min or other deviation from a central tendency) over the past X minutes. Alternatively, the weather service could provide pressure tendency, which is a measurement of pressure change rate (e.g., Y Pa/hour). Then, if the pressure distribution exceeds the pressure jump by a certain amount, or the pressure tendency multiplied by a time of interest exceeds the pressure jump by a certain amount, then the significant pressure change/jump could be attributed to pressure change and not an altitude change, so the significant pressure change/jump would not be used in the system and method herein. Alternatively, if the absolute value of the difference of the pressure change indicated by a weather service and the measured change is less than a threshold amount, then the significant pressure change/jump could be attributed to pressure change and not an altitude change, so the significant pressure change/jump would not be used in the system and method herein.

In some examples in which the geodatabase includes only terrain data and not building data, steps 1108, 1110 and 1112 need not be performed. Instead, the process 1100 proceeds through 1102, 1104 and 1106 to 1116. Additionally, 1116 is performed with the magnitude of the expected terrain altitude change (if any is determined at 1106) and optionally with a buffer taking into account the computing device 102 being held by the user above the ground/floor or noise effects or other contributions to the error budget of the pressure sensor, i.e., without the relative height of the building or relative height of highest accessible floor. Similarly, 1120 is performed with the magnitude of the expected terrain altitude change (if any is determined at 1106) and optionally with a buffer taking into account the computing device 102 being held by the user above the ground/floor or noise effects or other contributions to the error budget of the pressure sensor, i.e., without the relative height of the building or relative height of highest accessible floor. In this case, if the determination at 1120 is positive (yes), then the process 1100 branches to 1118 (instead of 1122) to return the determined value for the altitude change/jump (to 816 in FIG. 8) to be used as the processed altitude change/jump.

In some examples, the building might have a basement or below-ground levels. In this case, while building height data captures the space above ground, there could also be below-ground levels that are looked up from a database or that can be estimated using morphology (e.g., dense urban buildings that are likely to have below-ground levels contrasted with suburban homes that might not be likely to have basements). In such cases, the steps to process the altitude jumps augments building height with a below-ground depth, making the total building structure height to be: Building structure height=relative building height+below ground height. For example, a 20 m tall building that has 10 m of basement levels would be a 30 m structure from very bottom to very top. This total building structure height can be used as the constraint in 1116 and 1120 rather than the relative building height. Additionally, a building with a basement would be included as a “multi-story building” at step 1112.

FIG. 12 shows a simplified flowchart for an example process 1200 for updating (at 822) the cumulative altitude offset table 808, in accordance with some examples. The process 1200 may be performed by the system including the computing device 102 or the server 104 or an appropriate combination of functions in both the computing device 102 and the server 104. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after, or overlapping other steps, in spite of the illustrated order of the steps.

At 1202, the process 1200 cumulatively sums the most recent altitude change/jump values in the altitude offset table 820, up to the beginning of the table or the most recent reset entry or value. The process 1200 then determines (at 1204) whether the latest entry in the altitude offset table 820 is a reset entry. If not, then the process 1200 stores (at 1206) the cumulative sum (up to the most recent reset entry) as the latest entry in the cumulative altitude offset table 808. On the other hand, if the latest entry in the altitude offset table 820 is a reset entry as determined at 1204, then this causes the process 1200 to store (at 1208) the reset value (or 0.0 m) as the latest entry in the cumulative altitude offset table 808.

FIG. 13 shows simplified examples of the altitude offset table 820 and the cumulative altitude offset table 808, in accordance with some examples. Several timestamps are shown in a left column of both tables. The right column of the altitude offset table 820 shows the individual altitude change/jump values in meters. The right column of the cumulative altitude offset table 808 shows the cumulative sums of the individual altitude change/jump values in meters, wherein it is assumed that the first entries of both tables followed a reset entry. Additionally, the entries indicated at arrow A in the altitude offset table 820 and arrow B in the cumulative altitude offset table 808 (timestamp 7:45) are also reset entries, so the cumulative summation is reset to zero in the cumulative altitude offset table 808.

In some examples, the above-described techniques for determining an altitude or 3D location of the computing device 102 can be used in combination with techniques for determining whether to calibrate the barometric pressure sensor, e.g., using a conventional reference network of weather stations. For example, a significant pressure or altitude change/jump (detected by the above-described techniques) can be indicative of a situation that is not conducive to calibration of the barometric pressure sensor. This is because an altitude determined by the above-described relative pressure change or difference might not be very accurate, whereas sensor calibration generally requires relatively high accuracy. Therefore, if a significant pressure or altitude change/jump is determined to have occurred as described above, then pressure measurements from around the same time as the change/jump may be flagged as unsuitable for calibration due to potential instability in the measurements. Alternatively, if the cumulative altitude offset value is non-zero or is greater than or equal to an altitude change threshold of 0 m (for example+/−3 m), then pressure measurements from around the same time as the change/jump may be flagged as unsuitable for calibration against the terrain.

FIG. 14 illustrates components of an example of the base stations 106, an example of the computing devices 102, and an example of the system server 104 of the operational environment 100 shown in FIG. 1, in accordance with some examples. Examples of communication pathways are shown by arrows between components. The components shown in FIG. 14 are operable to perform all or a portion of the processes described with reference to FIGS. 1-13.

By way of example in FIG. 14, each of the base stations 106 may include: a computing device interface 11 for exchanging information with the computing devices 102 (e.g., antenna(s) and RF front-end components known in the art or otherwise disclosed herein); one or more processor(s) 12; memory/data source 13 for providing storage and retrieval of information and/or program instructions; a server interface 15 for exchanging information with the system server 104 (e.g., an antenna, a network interface, or other); and any other components known to one of ordinary skill in the art. The memory/data source 13 may include a non-transitory memory storing software modules with executable instructions, and the processor(s) 12 may perform different actions by executing the instructions from the modules, including (i) performance of a part or all of the methods or processes as described herein or otherwise understood by one of skill in the art as being performable at the base station 106; (ii) generation of positioning signals for transmission using a selected time, frequency, code, and/or phase; (iii) processing of signals received from the computing device or another source; or (iv) other processing as required by operations described in this disclosure. Signals generated and transmitted by a base station may carry different information that, once determined by a computing device or a server, may identify the base station's position and/or other positioning information known in the art.

By way of example in FIG. 14, the computing device 102 may include: a base station interface 21 for exchanging information with a base station (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the computing device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; a network interface 27 for exchanging information with the system server 104 or other devices external to the computing device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a non-transitory memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the computing device; (ii) estimation of an altitude of the computing device based on measurements of pressure from the computing device and terrain data, temperature measurement(s) from reference pressure station(s) or another source, and any other information needed for the computation; (iii) processing of received signals to determine position information (e.g., times of arrival or travel time of the signals, pseudoranges between the computing device and base stations, reference pressure station atmospheric conditions, and/or locations or other base station information); (iv) use of position information to compute an estimated position/location of the computing device; (v) determination of movement based on measurements from inertial sensors of the computing device; (vi) GNSS signal processing; (vii) determination of location context; (viii) other processing as required by operations described in this disclosure.

By way of example in FIG. 14, the system server 104 may include: a computing device interface 31 for exchanging information with a computing device (e.g., an antenna, a network interface, or other); one or more processor(s) 32; memory/data source 33 for providing storage and retrieval of information and/or program instructions; a base station interface 34 for exchanging information with a base station (e.g., an antenna, a network interface, or other); and any other components known to one of ordinary skill in the art. The memory/data source 33 may include a non-transitory memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the computing device; (iii) computation of an estimated position of the computing device; (iv) determination of location context; (v) other processing as required by operations described in this disclosure. Steps performed by servers as described herein may also be performed on other machines that are remote from a computing device, including computers of enterprises or any other suitable machine.

Certain aspects disclosed herein relate to estimating the positions of computing devices—e.g., where the position is represented in terms of latitude, longitude, and/or altitude coordinates; x, y, and/or z coordinates; angular coordinates; or other representations. Various techniques to estimate the position of a computing device can be used, including trilateration, which is the process of using geometry to estimate the position of a computing device using distances traveled by different “positioning” (or “ranging”) signals that are received by the computing device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the computing device. Different estimated distances corresponding to different positioning signals from different beacons can be used along with position information like the locations of those beacons to estimate the position of the computing device. Positioning systems and methods that estimate a position of a computing device (in terms of latitude, longitude, and/or altitude) based on positioning signals from beacons (e.g., transmitters, and/or satellites) and/or atmospheric measurements are described in co-assigned U.S. Pat. No. 8,134,141, issued Mar. 6, 2012, and U.S. Pat. No. 9,057,606, issued Jun. 16, 2015, incorporated by reference herein in their entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to examples of the disclosed invention, one or more examples of which have been illustrated in the accompanying figures. Each example has been provided by way of an explanation of the present technology, not as a limitation of the present technology. In fact, while the specification has been described in detail with respect to specific examples of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
detecting a pressure change based on pressure measurement data from a barometric pressure sensor of a computing device;
determining a 2D location of the computing device;
determining an altitude change of the computing device using the pressure change;
determining a cumulative altitude offset value by adding the altitude change to a previous cumulative altitude offset value;
determining a terrain-based altitude of the computing device based on the 2D location and terrain data from a geodatabase; and
determining an altitude of the computing device based on the terrain-based altitude and the cumulative altitude offset value.

2. The method of claim 1, further comprising:
determining a search area for the 2D location;
obtaining a maximum building height from the geodatabase based on the search area and the 2D location of the computing device for a building within the search area;
determining there is a multistory building or a building with a height above a tall threshold value within the search area;
determining that the altitude change is less than or equal to an expected terrain altitude change added to the maximum building height; and
determining the cumulative altitude offset value by adding the altitude change to the previous cumulative altitude offset value.

3. The method of claim 1, further comprising:
determining a search area for the 2D location;
determining that there is not a multistory building or a building with a height above a tall threshold value within the search area; and
setting the cumulative altitude offset value to a reset value.

4. The method of claim 1, further comprising:
determining a search area for the 2D location;
obtaining a maximum building height from the geodatabase based on the search area and the 2D location of the computing device for a building within the search area;
determining there is a multistory building or a building with a height above a tall threshold value within the search area;
determining that the altitude change is not less than or equal to an expected terrain altitude change added to the maximum building height;
determining that the altitude change is not within an acceptable excess altitude threshold value of the expected terrain altitude change added to the maximum building height; and
setting the cumulative altitude offset value to a reset value.

5. The method of claim 1, further comprising:
determining a search area for the 2D location;
obtaining a maximum building height from the geodatabase based on the search area and the 2D location of the computing device for a building within the search area;
determining there is a multistory building or a building with a height above a tall threshold value within the search area;
determining that the altitude change is not less than or equal to an expected terrain altitude change added to the maximum building height;
determining that the altitude change is within an acceptable excess altitude threshold value of the expected terrain altitude change added to the maximum building height; and
using the maximum building height as the altitude change.

6. The method of claim 5, further comprising:
setting the cumulative altitude offset value to a reset value in response to determining that the altitude change is within the acceptable excess altitude threshold value more than an error threshold number of times in a row.

7. The method of claim 5, further comprising:
using the maximum building height as the altitude change in response to determining that the altitude change is in an upward direction; and
setting the cumulative altitude offset value to a reset value in response to determining that the altitude change is in a downward direction.

8. The method of claim 1, further comprising:
determining a search area for the 2D location;
obtaining the terrain data from the geodatabase based on the search area and the 2D location of the computing device;
determining an expected terrain altitude change using the terrain data;
obtaining a maximum building height from the geodatabase based on the search area and the 2D location of the computing device for a building within the search area;
determining whether there is a multistory building or a building with a height above a tall threshold value within the search area based on building data from the geodatabase;
upon determining there is not a multistory building or a building with a height above a tall threshold value within the search area, setting the cumulative altitude offset value to a reset value;
upon determining there is a multistory building or a building with a height above a tall threshold value within the search area, determining whether the altitude change is less than or equal to the expected terrain altitude change added to the maximum building height;
upon determining that the altitude change is less than or equal to the expected terrain altitude change added to the maximum building height, determining the cumulative altitude offset value by adding the altitude change to the previous cumulative altitude offset value;
upon determining that the altitude change is not less than or equal to the expected terrain altitude change added to the maximum building height, determining whether the altitude change is within an acceptable excess altitude threshold value of the expected terrain altitude change added to the maximum building height;
upon determining that the altitude change is not within the acceptable excess altitude threshold value of the expected terrain altitude change added to the maximum building height, setting the cumulative altitude offset value to the reset value; and
upon determining that the altitude change is within the acceptable excess altitude threshold value of the expected terrain altitude change added to the maximum building height, using the maximum building height as the altitude change.

9. The method of claim 1, wherein:
detecting the pressure change further comprises determining whether the pressure measurement data satisfies a set of criteria.

10. The method of claim 9, wherein:
when the pressure measurement data satisfies the set of criteria, adding the pressure change to a list of potential pressure change candidates that includes other pressure changes, combining the pressure change with any of the other pressure changes that overlap with the pressure change in time or are adjacent to the pressure change in time, and using a resulting combined pressure change as the pressure change.

11. The method of claim 1, further comprising:
monitoring the pressure measurement data from the barometric pressure sensor of the computing device to generate a plurality of pressure measurements, which includes a first portion of the plurality of pressure measurements collected during a first time period, a second portion of the plurality of pressure measurements collected during a second time period that occurs after the first time period, and a third portion of the plurality of pressure measurements collected during a third time period that occurs after the second time period;
and wherein:
detecting the pressure change further comprises determining whether the pressure measurement data satisfies two or more of a first criterion, a second criterion, a third criterion, a fourth criterion, a fifth criterion, and a sixth criterion;
the pressure measurement data satisfies the first criterion when the first portion of the plurality of pressure measurements is within a beginning stable pressure threshold range and the first time period is within a beginning stable time threshold range;
the pressure measurement data satisfies the second criterion when the third portion of the plurality of pressure measurements is within an ending stable pressure threshold range and the third time period is within an ending stable time threshold range;
the pressure measurement data satisfies the third criterion when the second time period is within a transition duration threshold range;
the pressure measurement data satisfies the fourth criterion when a magnitude of the pressure change is greater than or equal to a magnitude threshold;
the pressure measurement data satisfies the fifth criterion when a rate of the pressure change is within a rate threshold range; and
the pressure measurement data satisfies the sixth criterion when an overall variation of second pressure measurement values of the second portion of the plurality of pressure measurements does not exceed a difference between first pressure measurement values of the first portion of the plurality of pressure measurements and third pressure measurement values of the third portion of the plurality of pressure measurements.

12. The method of claim 11, wherein:
the beginning stable pressure threshold range is about 5-10 Pa, and the beginning stable time threshold range is about 5-10 seconds;
the ending stable pressure threshold range is about 5-10 Pa and the ending stable time threshold range is about 5-10 seconds;
the transition duration threshold range is about 5-60 seconds;
the magnitude threshold is greater than or equal to about 30 Pa, and the magnitude of the pressure change is a difference between a first average pressure value of the first portion of the plurality of pressure measurements and a second average pressure value of the third portion of the plurality of pressure measurements; and
the rate threshold range is about 0.5-30 Pa/second.

13. The method of claim 11, wherein:
detecting the pressure change further comprises determining whether the pressure measurement data satisfies three or more of the first criterion, the second criterion, the third criterion, the fourth criterion, the fifth criterion, and the sixth criterion.

14. The method of claim 11, wherein:
detecting the pressure change further comprises determining whether the pressure measurement data satisfies four or more of the first criterion, the second criterion, the third criterion, the fourth criterion, the fifth criterion, and the sixth criterion.

15. The method of claim 11, wherein:
detecting the pressure change further comprises determining whether the pressure measurement data satisfies five or more of the first criterion, the second criterion, the third criterion, the fourth criterion, the fifth criterion, and the sixth criterion.

16. The method of claim 11, wherein:
detecting the pressure change further comprises determining whether the pressure measurement data satisfies all of the first criterion, the second criterion, the third criterion, the fourth criterion, the fifth criterion, and the sixth criterion.

17. The method of claim 1, further comprising:
storing the altitude change and a timestamp therefor as a most recent altitude change to an altitude offset table that includes a plurality of altitude changes;
summing the plurality of altitude changes from a most recent reset entry to the most recent altitude change to generate a cumulative sum of altitude changes;
when a most recent entry in the altitude offset table is a reset entry, storing a reset value in a cumulative altitude offset table; and
when the most recent entry in the altitude offset table is not a reset entry, storing the cumulative sum of altitude changes in the cumulative altitude offset table.

18. The method of claim 1, further comprising:
causing the cumulative altitude offset value to be reset in response to determining that the computing device had been powered off.

19. The method of claim 1, further comprising:
causing the cumulative altitude offset value to be reset in response to determining that an inactive time period of the computing device has occurred for longer than an inactive threshold time period.

20. The method of claim 1, further comprising:
causing the cumulative altitude offset value to be reset in response to determining that the 2D location of the computing device changed unphysically.
